(19) United States
(12) Patent Application Publication
(10) Pub. No.: US 2010/0011412 A1
(43) Pub. Date: Jan. 14, 2010

(54) METHOD FOR MANAGING CRYPTOGRAPHIC EQUIPMENT WITH A UNIFIED ADMINISTRATION

(75) Inventors: Benoit Maximilien, Le Chesnay (FR); Emmanuel Auge, Nuaille (FR)

Correspondence Address: DARBY & DARBY P.C., P.O. BOX 770, Church Street Station, New York, NY, 10008-0770, US

(73) Assignee: Thales, Neuilly Sur Seine (FR)

(21) Appl. No.: 12/430,262

(22) Filed: Apr. 27, 2009

(30) Foreign Application Priority Data
Apr. 25, 2008 (FR) 0802340

(51) Int. Cl. G06F 17/00

(52) U.S. Cl. 726/1; 380/59

(57) ABSTRACT

A unified and universal management system for one or more items of cryptographic equipment, comprising a federating portal that is adapted to allow a user to access services, one or more interfaces for the interchange of information between the management system and equipment outside the system, one or more modules having one or more sub-modules or technological bricks suitable to carry out a unified and universal management method.

### CROSS REFERENCE TO RELATED APPLICATION

The present application claims the benefit of French Application No. 0802340, filed on Apr. 25, 2008, which is hereby incorporated by reference in its entirety.

### FIELD OF THE INVENTION

The invention relates to a method making it possible to manage cryptographic equipment present within a network. It is used notably to obtain systems managed automatically while observing the security guarantees required in most applications using data encryption. It applies, notably, in the field of secure bank transactions.

### PRIOR ART

One of the problems that exists in the field of information systems security relates to the management of the cryptographic equipment in a network.

Usually, the networks comprise specific management centres which, as they multiply, transfer a considerable weight to the operators (government users, major account users such as manufacturers, banks, etc.). There is therefore currently a need to find a solution of adjustable management making it possible to rationalize both the human and hardware resources of the customers.

With respect to security, it is crucial to manage security equipment. Specifically, a certain number of services is necessary for the administration of the cryptographic equipment, whether it be civil or defense equipment. Although there are specifications because of the protocols used for each application, the systems comprise technological bricks, or blocks, each having a well-defined functionality according to a need or an application and/or similar services in all the management systems. The way in which they are used differs from one application to another.

Another problem encountered in the security field is the users' desire to have a single man-machine interface or MMI that is user-friendly and can be modulated according to the mission that they have to accomplish or the given needs of an application. In other words, each technological brick has its own interface and the presentation of all the uploaded data no longer allows a correct interpretation of the network or security events. In the face of this multiplication of interfaces, there is a need to develop a single tool which concentrates, synthesizes, correlates as appropriate, and displays the data that the user needs.

These problems are encountered for example, in the following applications: high bit rate IP (Internet Protocol) encryptors, encryptors of data links in particular Ethernet, firewalls, etc.

Various systems exist in the prior art which offer modular management solutions. However, these systems in most cases require fixed, heterogeneous, specific and complex management. Therefore, the network security products known to the Applicant have the particular feature of using elements that are proprietary in terms of interface, protocol, algorithm, use and contexts of use. These specifics prevent interworking and mutualization in the operation of the devices.

There is therefore a need to rationalize both the hardware and human resources used in the systems. As an example, the technological bricks known to those skilled in the art that are used for the management of network equipment and their supervision are for example:

Opentrust PKI, Unicert (Cybertrust), NAGIOS (freeware), TIVOLI/NETCOOL (IBM), HPOV-NNM from Hewlett-Packard, Openview from Hewlett-Packard, Unicenter Networks and Systems Management from Computer Associates, CiscoWorks and Security Device Manager from Cisco Systems, Patrol Dashboard from BMC Software, SNMPC from Castlerock, VistaInsight from InfoVista, etc.

Furthermore, the technological bricks that are also known to those skilled in the art that may be cited for security administration are, for example: Network Security Policy System, Security Management System and Guided Response System from ExaProtect (the offer includes the Security Policy Management product following the buy-out of Solsoft), Enterprise Security Manager from ArcSight, Security Manager from NetIQ, Monitoring, Analysis and Response System from Cisco Systems, InSight Suite from Consul risk management, Security Information Manager from Symantec, eTrust Security Command Center from Computer Associates (CA), Security Manager from Intellitactics, nFX Open Security Platform from netForensics, Sentinel from Novell (formerly e-Security's flagship product), envision from Network Intelligence, Enterprise Security Analyzer from eIQnetworks.

The idea of the present invention lies notably in structuring cryptographic equipment management as unitary (i.e., unified) and independent services which are federated via a “specialism”-oriented man-machine interface, that is to say that is able to be modulated according to the permissions attached to a function and the mission of a user. Notably it provides the advantage of satisfying all or at least most of the cryptographic equipment management needs.

### SUMMARY OF THE INVENTION

The invention relates to a unified and universal management system for one or more items of cryptography equipment, characterized by a service-oriented architecture in that it comprises in combination at least the following elements:
a federating portal that is adapted and adaptable to the specialism of the user or of the operator for allowing a user to access various individual and independent services,
these individual and independent services are modular technological bricks comprising one or more sub-modules chosen from the following list:
   a Secrets management module (key production, directory management, etc.),
   a Security Policy Management module (protection policy, access control policy, etc.),
   an operational module OPS,
   a module responsible for the administration of the items of equipment (pre-personalization, personalization, registration, enrolment, etc.),
   a Supervision module (alarms management, management of technical facts, incidents and unsolicited events, correlation of events, etc.)
   an Audit module (auditing of the correct application of the Security Policy: logs, policy applied and reporting by the items of equipment, etc.)
   a Monitoring module (population management, status and location of equipment, etc.),
   an Authentication module (management of user profiles, administrators, auditors, etc. authentication of the people involved, etc.).
One or more interfaces allowing the interchange of information between the management system and cryptographic equipment outside the said system.

A module or technological brick includes, for example, of three layers corresponding to a unitary service. It may comprise at least the following three layers: a first layer corresponding to a man-machine interface presentation module, a second layer corresponding to the desired processes and a third layer corresponding to a database.

The system has a service-oriented architecture SOA including individual and independent technological bricks and may comprise a set of bricks or modules suitable for the administration of cryptographic equipment and for producing “secrets” for the information systems security field comprising an authentication module, a module suitable for generating secrets, an audit module.

According to one embodiment, the system comprises at least one set of bricks or modules comprising the following modules:

Module AUTH: for authenticating and accessing the services,
Module SECRET: for accessing the secrets produced and managing their allocation, generating associated keys,
Module AUDIT: for consulting the local logs,
Module POLICY: for defining a policy for access to the equipment (administrators and the permissions),
Module ADMIN: for supplying the pre-personalization data and assigning them to the items of equipment,
Module MONITORING: for keeping up to date the equipment status database (status, monitoring of the ACSSI, updating as appropriate, etc.).

According to another embodiment, the system comprises a set of bricks or modules comprising the following modules:

Module AUTH: for authenticating and accessing the services,
Module SECRET: for accessing the secrets produced and managing their allocation, generating associated keys,
Module AUDIT: for consulting the local logs,
Module POLICY: for defining a policy for access to the equipment (administrators and the permissions),
Module ADMIN: for supplying the pre-personalization data and assigning them to the items of equipment,
Module MONITORING: for keeping up to date the equipment status database (status, monitoring of the ACSSI, updating as appropriate, etc.).

According to another embodiment, the system may comprise a set of bricks or modules comprising the following elements:

AUTH: for authenticating and accessing the services,
POLICY: for defining the policies of the equipment (encryption policy, certification policy, access policy: permissions and roles of the people involved, protections policy, etc.),
AUDIT: for consulting the local logs.

According to one embodiment, the system comprises a set of bricks or modules comprising the following elements:

AUTH: for authenticating and accessing the services,
AUDIT: for consulting the local logs,
POLICY: for accessing the policy to be allocated to the equipment
OPS: for defining the additional operational parameters of the equipment (frequency plan, telephone directory, routing table, etc.), parameters associated with the operational purpose of the equipment.
ADMIN: for supplying the equipment with all the configuration data or updating these parameters.

The system may also comprise a set of bricks including the following modules:

AUTH: for authenticating and accessing the services,
POLICY: for accessing the IPSec security policy (part of the policy to be allocated to the equipment to be managed),
SECRET: for accessing the secrets defined and managing their allocation,
OPS: for defining the additional operational parameters of the equipment (IP routing table, etc.).
ADMIN: for enrolling the items of equipment on the management system, for personalizing them and providing them with the configuration files in order to control them remotely,
SUPERV: for having a view, in different forms, of the state of the service and equipment in charge of the service (alarms, mapping, status LEDs, performance, etc.),
AUDIT: for consulting the logs and database of the entities contributing to the maintenance of the service (local logs, logs of other entities, logs of the supervised cryptographic equipment, network MIBs, etc.) and for checking that the policy applied complies with the policy defined;
MONITORING: for keeping up to date the equipment status database (status, monitoring of sensitive components, software update as necessary, etc.).

The subject of the invention also relates to a system wherein it comprises a set of bricks including the following modules:

AUTH: for authenticating and accessing the services,
POLICY: for having the policy intended to be applied by the equipment (the instruction),
AUDIT: for consulting the logs and the policies of the equipment and analysing them.

### BRIEF DESCRIPTION OF THE DRAWINGS

Other features and advantages of the device according to the invention will appear more clearly on reading the following description of an exemplary embodiment given as an illustration and in no way limiting with the attached figures which represent:

FIG. 1, an exemplary architecture which shows the concept and the breakdown into layers specific to an administration system according to the invention for the unified and universal management of cryptographic equipment,

FIG. 2, an exemplary concept of “3-tier” applications which still including a man-machine interface, MMI, layer, a processing layer and a data layer (or database),

FIG. 3 shows the whole structure of a services-oriented architecture, and

FIGS. 4 to 14 show various exemplary embodiments of the system described in FIG. 1.

### DETAILED DESCRIPTION OF THE PREFERRED EMBODIMENTS

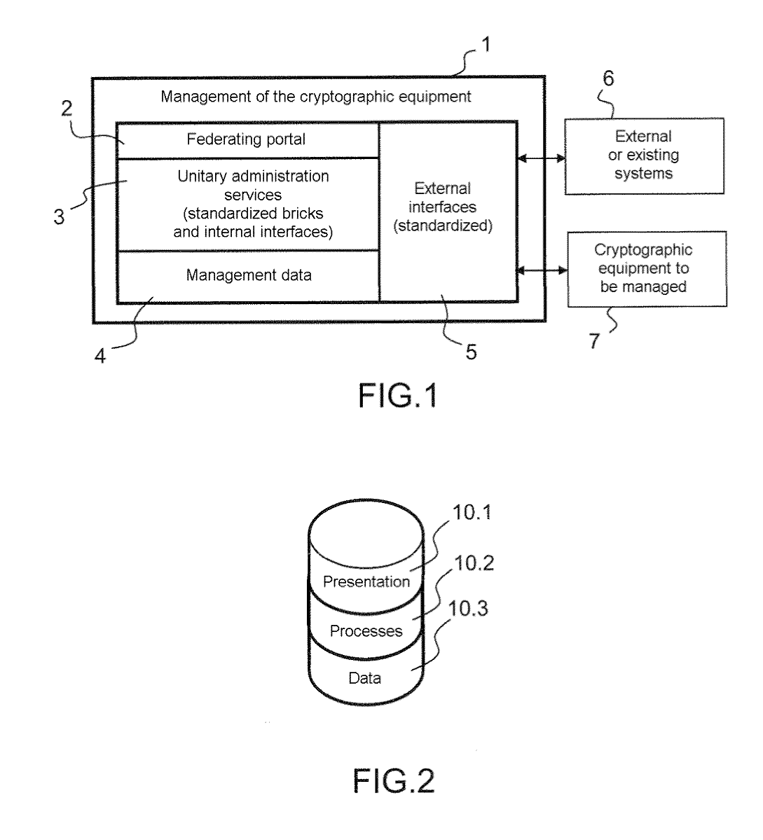

FIG. 1 describes an exemplary architecture of a system according to the invention based on a modular, adjustable and open-ended technical concept.

The system according to the invention comprises a module 1 for managing cryptographic equipment comprising at least the following elements placed in layers:
a federating portal 2 having the function of an entrance door or access portal allowing a user to access the various services that are useful for the management of the cryptographic equipment, for example the various unitary management services provided by technological bricks represented hereinafter by modules and detailed below by means of exemplary embodiments.

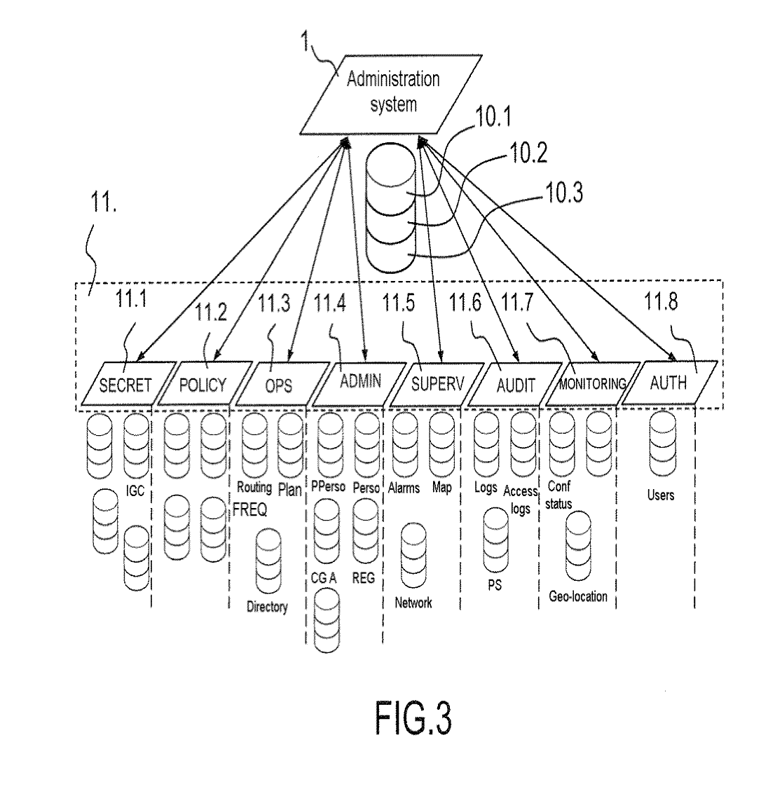

Therefore, the portal 2 adapted to personalize the content of the interfaces in order to adapt them to the mission or the needs of a user, some examples of which are detailed as an illustration with respect to the following figures:
A module 3 including a set of technological bricks which represent the individual services used for the management of all the cryptographical security products and which comprises one or more of the following elements (FIG. 3):
   A Secrets management module (production of the Key Management Infrastructure, IGC, keys, management of the directories, etc.), 11.1
   A Security Policy Management module (protection policy, access control policy, etc.), 11.2
   An OPS (OPen Services: a module left open to the specific needs of the customer or the operators) operational module 11.3 containing for example the frequency plan or plans, the routing plan, the directory, etc.
   A module responsible for the Administration of the equipment (pre-personalization, personalization, registration, enrolment, etc.), 11.4
   A Supervision module (alarms management, management of technical facts, incidents and unsolicited events, correlation of events, etc.) 11.5
   An Audit module (auditing of the correct application of the Security Policy: logs, policy applied and reporting by the items of equipment, etc.) 11.6
   A Monitoring module (population management, status and location of equipment, etc.), 11.7
   An Authentication module (management of user profiles, administrators, auditors, etc. authentication of the people involved, etc.), 11.8.
   A data management module 4.

The various modules are represented for simplification purposes by the reference number 3 in FIG. 1 and detailed in FIG. 3.

The federating portal 2, the administration module comprising the various technological bricks 3 and the data management module 4 are connected with one or more external interfaces 5 known to those skilled in the art and standardized.

This or these external interfaces 5 are used for the communication and interchange of data with either external systems 6, or cryptographic equipment 7 to be managed. The latter are based on known standards such as SNMP (Simple Network Management Protocol), SYSLOG (interchange protocol for event logs), etc.

The architecture described in FIG. 1 notably makes possible:
A multi-product, multi-context and multi-level management;
A standardization of the interchanges between the bricks inside the management, and the management and the external systems.

The OPS services are reserved for the particular services of the users and they are associated with his activity (definition of a frequency plan for his high frequency HF communications, programming of the electromagnetic frequency plan for a radar, definition of his IP routing tables, definition of his community, that is to say of the parameters of a user group with which communication will be established, etc.).

FIG. 2 schematizes an example of a three-layered unitary service.

The concept of 3-tier applications corresponds to a software program including a first layer 10.1 corresponding to a Man-Machine Interface (MMI) presentation module, a module 10.2 corresponding to the processes and a module 10.3 corresponding to a database.

Each module or technological brick is composed according to a three-tier software format and each cylinder thus constituted may itself be broken down into sub-services, or smaller cylinders themselves broken down into three tiers. This breakdown and the services are known to those skilled in the art and will not be explained in detail.

FIG. 3 represents an example of a management set comprising a single access portal 11 connected with various applications 11.i. The applications are explained in detail in the following figures and may use one or more of the following functionalities:

11.1, the generation of a secret comprising for example a directory, a module for the management and production of the encryption keys, a module for security and cryptography for the networks, 11.2, the security policy chosen by a user, an OPS module 11.3 comprising routing modules, frequency plan modules and also directories, an Administrator module 11.4, a supervision module 11.5 including for example alarms, mapping etc., an audit module 11.6 including the means for connecting the users responsible for the audits, a module 11.7 for monitoring the items of equipment for correct operation and a module 11.8 for authenticating the users of the system.

The following figures represent examples of adapting the architecture of the system according to the invention according to the roles and missions previously determined.

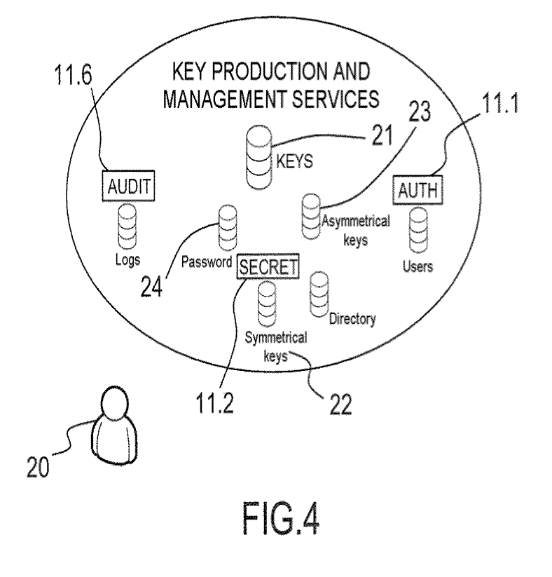

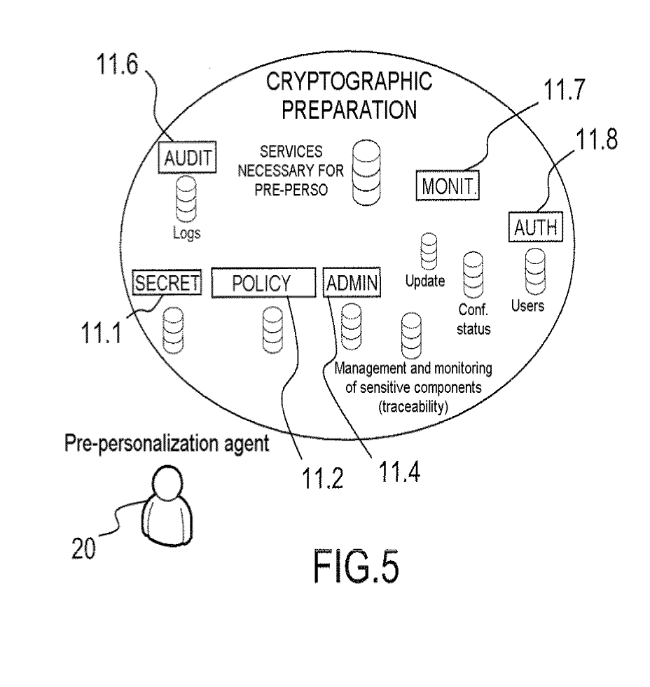

FIG. 4 represents a brick which forms part of the management system according to the invention and which notably has the function of generating “Secrets”. This mission is entrusted to the encryption manager 20 (the security officer or to the person in charge of generating the keys which may be the security manager within a company).

The responsible person will use the following modules:

The authentication module 11.1 for authenticating and accessing the services,
The secret module 11.2 for producing and generating the secrets, for example the keys 21, symmetric or asymmetric keys for protecting the interchanged data, the passwords 24 according to the people,
The module 11.6 or Audit for consulting the local logs which collect all the events (for example the network incidents), alarms (for example, the security-related alarms), the operating states (of the cryptographic equipment). In general, all these technical facts are recorded, dated and saved in a database not shown in the figure for simplification purposes. Thereafter, the manager 20 may alert, correlate (which may also be done by an analysis tool in order to detect a service denial or else system software attacks, etc.), diagnose a fault, carry out a repair or else ignore the latest events.

FIG. 5 represents a second example of use of the system according to the invention which allows a customer of a system to personalize his equipment and prepare it cryptographically. For example, the cryptographic preparation will involve the registration of the equipment (allocating the equipment to an organization, a management system (enrolment with a management with allocations of the authorizations) with or else to a user, the application of the key (the injection of the first secrets), the updating of software, and the definition of a chosen or security access policy (the list of possible contacts between several items of equipment, network parameters for authorized interchanges, etc.).

In this embodiment of the system according to the invention, the customer will use the following modules:

Module 11.8 AUTH: for authenticating and accessing the services,
Module 11.1 SECRET: for accessing the secrets produced and managing their allocation, generating associated keys,
Module 11.6 AUDIT: for consulting the local logs,
Module 11.2 POLICY: for defining a policy for access to the equipment (administrators and the permissions),
Module 11.4 ADMIN: for supplying the pre-personalization data and assigning them to the items of equipment,
Module 11.7 MONITORING: for keeping up to date the equipment status database (status, monitoring of the ACSSI, updating as appropriate, etc.).

The steps for implementing a unified administration system according to the invention taken by a user after authentication (AUTH module) are, for example: the phases of applying the key, of registration (SECRET module), of programming or of configuration, of enrolment with a management (ADMIN module), of defining the security policy (POLICY module), of auditing for ensuring that the latter is in fact applied (AUDIT module) and then of monitoring and management of populations (MONITORING module). In other words, the user personalizes the equipment to an extent, gives it the means to communicate with his community (the keys, the secrets), makes it known to the latter (by means of his management) and controls it (network behavior, etc.).

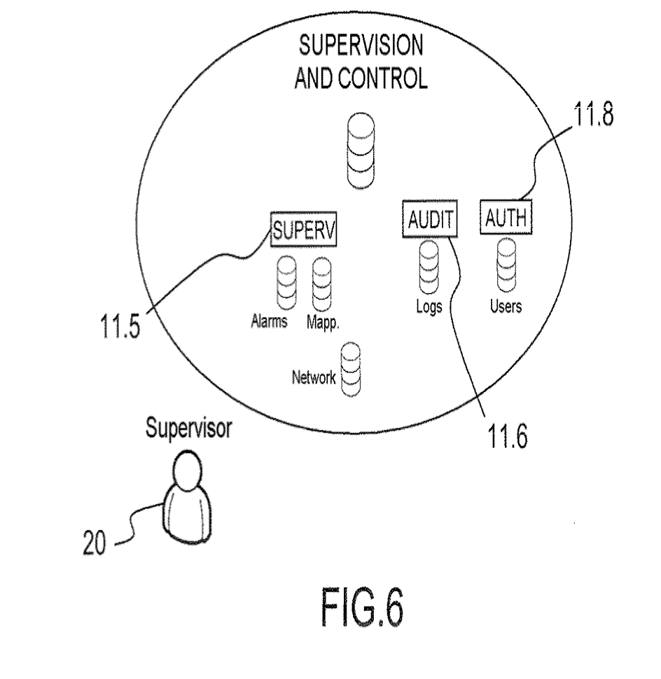

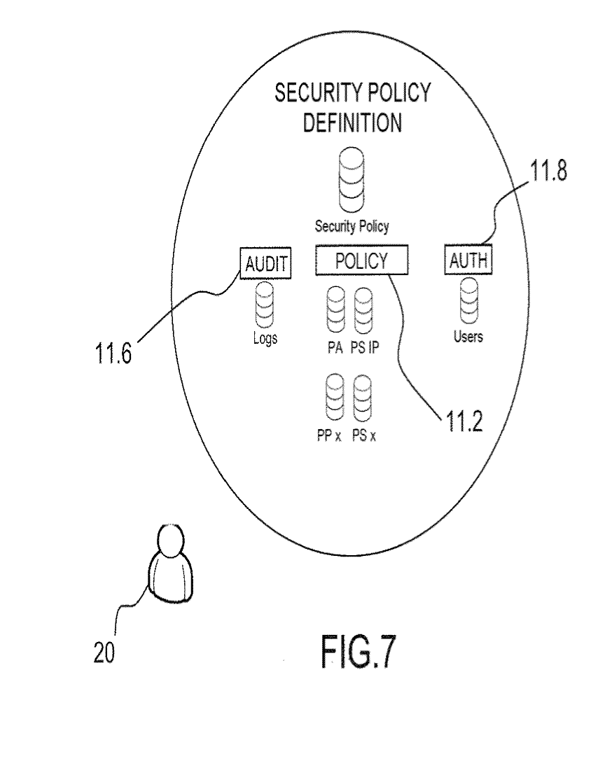

FIG. 6 schematizes an example of use of the system according to the invention for monitoring, supervising and if necessary auditing the population of equipment. This mission is usually entrusted to a supervisor of whom this may or may not be the main role.

To carry out his mission, he should have access to the following services:

AUTH 11.8: for authenticating and accessing the services,
SUPERV 11.5: for having a view, in different forms, of the state of the service and equipment in charge of the service (alarms, mapping, status LEDs, performance, etc.),
AUDIT 11.6: for consulting the logs and database of the entities contributing to the maintenance of the service (local logs, logs of other entities, logs of the supervised cryptographic equipment, network MIBs, etc.).

In this case, the user, after having authenticated himself (AUTH module) will supervise his network using various tools (technological bricks of his SUPERV module) in order to control the uploading of information (events, logs, alarms, network incidents, etc.) from a database (a list of all registered items of equipment, etc.), to update this database and carry out network and/or security repairs if necessary (according to the collected information (AUDIT module)).

FIG. 7 represents an example of an application of the structure according to the invention in order to define the security policy with respect to the system requirements, the requirements of the equipment and of their capabilities: that is to say who has the right to communicate with whom, in what conditions (with which level of service, etc.) but also how the equipment should behave with respect to legal or illegal access attempts (access permissions, etc.).

To carry out his mission, he should have access to several services:

AUTH 11.8: for authenticating and accessing the services,
POLICY 11.2: for defining the policies of the equipment (encryption policy, certification policy, access policy: permissions and roles of the people involved, protections policy, etc.)
AUDIT 11.6: for consulting the local logs.

In this case, after authenticating himself, the user first of all defines the security policy which can be summarized as the establishment of virtual private tunnels (VPN) between two entities that are authorized to communicate (POLICY module) and then checks that it is correctly applied (AUDIT module) by means of various techniques (polling, automatic upload of the security policy, etc.).

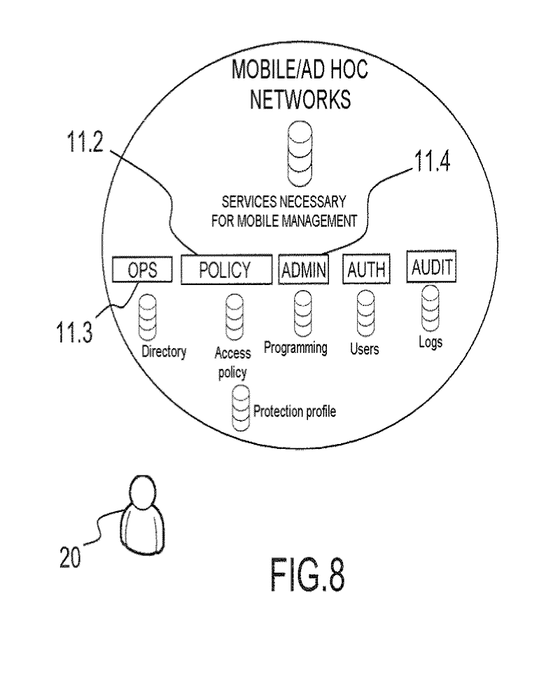

FIG. 8 represents an exemplary embodiment of the system according to the invention in order to manage an ad hoc network in a simplified manner. This embodiment is usually entrusted to a cryptographic equipment administrator. The latter will use the following functionalities:

AUTH 11.8: for authenticating and accessing the services,
AUDIT 11.6: for consulting the local logs,
POLICY 11.2: for accessing the policy to be allocated to the equipment,
OPS 11.3: for defining the additional operational parameters of the equipment (frequency plan, telephone directory, routing table, etc.), parameters associated with the operational purpose of the equipment,
ADMIN 11.4: for supplying the equipment with all the configuration data or updating these parameters.

In this case, the application made by the user 20 operating the mobile/ad hoc/local area network (after authentication: AUTH module) is simpler than for a complete management system because the object is to propose remote administration services closer to the operating conditions (use of the OPS module). However, the fundamental blocks that should be driven as close to the ground and its constraints as possible are again found: POLICY module (for defining the security policy and establishing the links between the entities that are authorized to communicate), and ADMIN (in order to program the equipment according to the network specifics: bit rates, flow prioritization, resource allocation, availability requirement, quality of service, etc.).

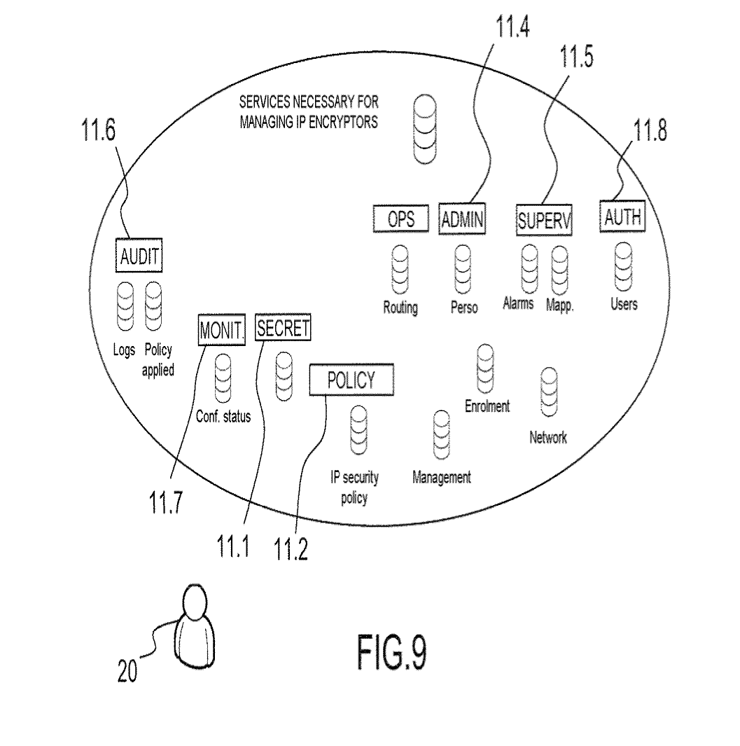

FIG. 9 represents an application example used by a supervisor 20 of the infrastructure cryptographic equipment for the management of IP encryptors.

To carry out his mission, the administrator will use the following functionalities:

AUTH 11.8: for authenticating and accessing the services,
POLICY 11.2: for accessing the IPSec security policy (part of the policy to be allocated to the equipment to be managed),
SECRET 11.1: for accessing the secrets defined and managing their allocation,
OPS 11.3: for defining the additional operational parameters of the equipment (IP routing table, etc.).
ADMIN 11.4: for enrolling the items of equipment on the management system, for personalizing them and providing them with the configuration files in order to control them remotely,
SUPERV 11.5: for having a view, in different forms, of the state of the service and equipment in charge of the service (alarms, mapping, status LEDs, performance, etc.),
AUDIT 11.6: for consulting the logs and database of the entities contributing to the maintenance of the service (local logs, logs of other entities, logs of the supervised cryptographic equipment, network MIBs, etc.) and for checking that the policy applied complies with the policy defined;
MONITORING 11.7: for keeping up to date the equipment status database (status, monitoring of sensitive components, software update as necessary, etc.).

In this case the administrator has a complete role of managing the cryptographic equipment (once he has authenticated himself: AUTH module). Specifically, he should renew the security policy (defined moreover by the security officer or the security manager (POLICY module)), renew the keys (SECRET module), update the equipment configuration, (OPS and ADMIN modules), update his databases containing the items of equipment that have been registered (ADMIN module), supervise (SUPERV module) and/or audit his system (AUDIT module).

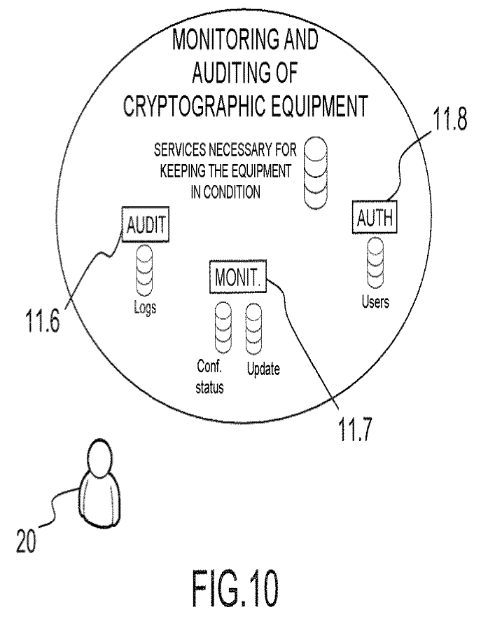

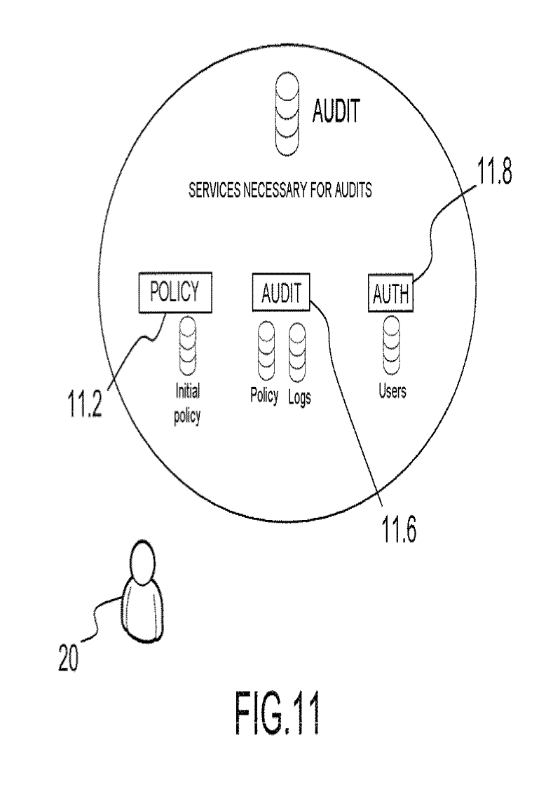

The example given in this FIG. 10 relates to the use of the system according to the invention in order to prepare or maintain the equipment so that they can fulfill their function correctly (choosing the software version, periodic maintenance operation, etc.).

To carry out his mission, the controller 20 should have access to several services:

AUTH 11.8: for authenticating and accessing the services,
MONITORING 11.5: for keeping up to date the equipment status database (status, monitoring of the ACSSI, software update, etc.).
AUDIT 11.6: for consulting the local logs and the logs of the cryptographic equipment maintained.

In this case, the user carries out monitoring and auditing once his system has been defined.

In this FIG. 11, the system according to the invention is used to control the correct behavior of the items of equipment and their status relative to the nominal instructions and to verify the nominal and non-nominal events that they have stored (logs, security policy, status, etc.).

To carry out his mission, he should have access to several services:

AUTH 11.8: for authenticating and accessing the services,
POLICY 11.2: for having the policy intended to be applied by the equipment (the instruction),
AUDIT 11.6: for consulting the logs and the policies of the equipment and analysing them.

In this case, the authenticated user audits his security policy once it has been defined and communicated to the equipment.

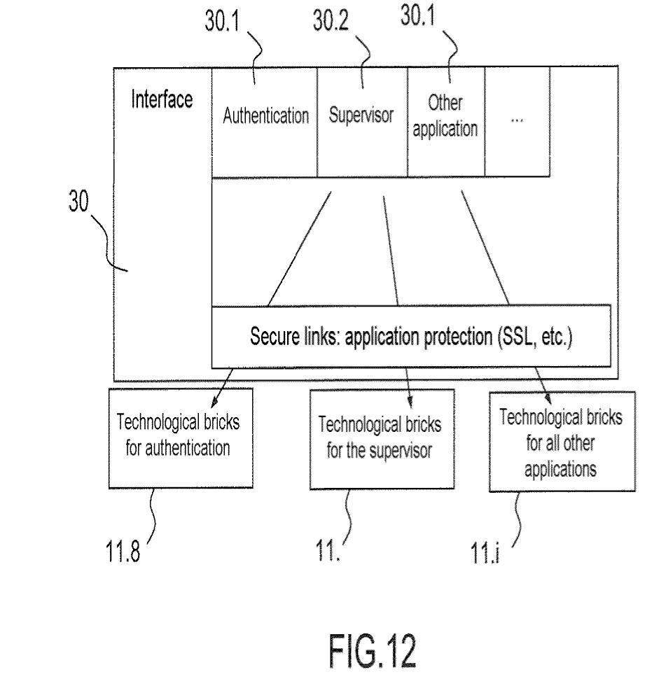

FIG. 12 represents a software implementation example for an SOA (Services-Oriented Architecture) and web services architecture. This implementation comprises an interface 30, various computer applications 31.i which make it possible to dynamically process requests from users wishing to access services through customized views, for example, JSR 268 (http://fr.wikipedia.org/wiki/JSR_{—}168), FSR 286, WSRP (http://fr.wikipedia.org/wiki/WSRP), etc.

The services are distributed over several software machines. The protocols used are standard: SOAP (requests and data based on numerous transport protocols: HTTP, SMTP, POP3, FTP, etc. thus the SOAP allows XML data interchanges between services such as routing parameters, recipients' addresses, etc.), XML (eXtended Markup Language), WSDL (the interface for access to web services), UDDI standard (dynamic location of web services, SAML (Security Assertion Markup Language: the security standard for authentication and access authorization), XACML the description of the policies for access to the resources, the URI (http services addressing mode for the naming of the resources or services), XKMS (XML Key Management Specification server for communication with PKIs (public key infrastructure) and for simplified management of the digital certificates), etc.

The purpose is to define a service contract between a technological brick and the federator, that is to say between a provider entity and a customer entity.

The users thus have, via a single portal, a personalized interface (MMI) the user-friendliness of which is adapted to their mission. Irrespective of their mission, they find a familiar user-friendliness (rationalization of the user interfaces). In addition, with the use of SSO (Single Sign-On) principles and new technologies such as the SAML, the user has to authenticate himself only once to this modular Framework.

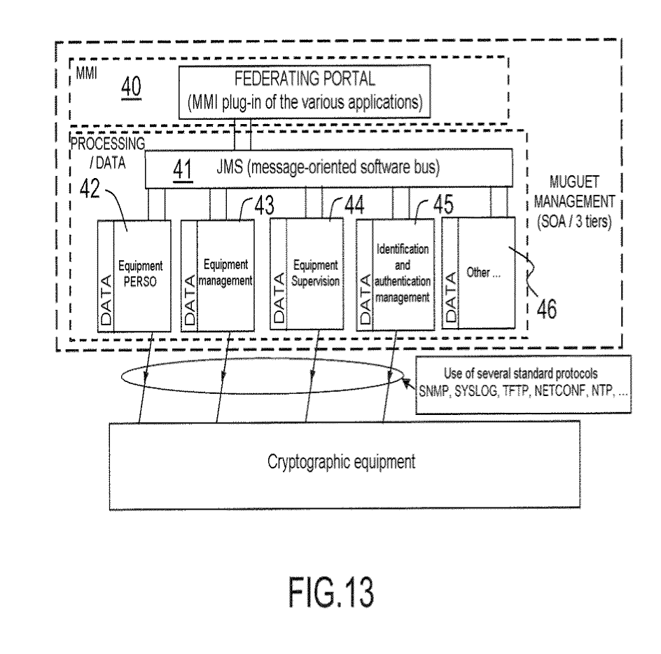

FIG. 13 represents another example of interchange bus-oriented SOA software implementation or ESB (Enterprise Service Bus), JMS (Java bus). The Java Message Service (JMS) programming interface makes it possible to send and receive messages between applications or Java components. The JMS service transports messages between two technological bricks or more:
either in “publish and subscribe” mode in asynchronous manner. In this case, the “client/receiver” or “server/producer” entities do not know one another (the principle of subscription to a message class),
or in point-to-point mode (in synchronous manner) where the entities know one another (the queue principle).

The SOA architectures make it possible to use transverse driving of the cryptographic equipment. This allows a great deal of open-endedness because the changing of a brick in no way changes the whole system. This architecture supports heterogeneous technologies if there is an interface with the Java bus.

Then, each technological brick uses the JAVA Runtime Environment (or JRE) which is a set of tools allowing the running of Java programs on all platforms (that support it). JRE including a JVM (Java Virtual Machine) and a standard library with all the Java programs. The Java technology is a guarantee of portability in client-server architectures thereby facilitating migration between servers, very difficult for big systems, and the integration of new technological bricks.

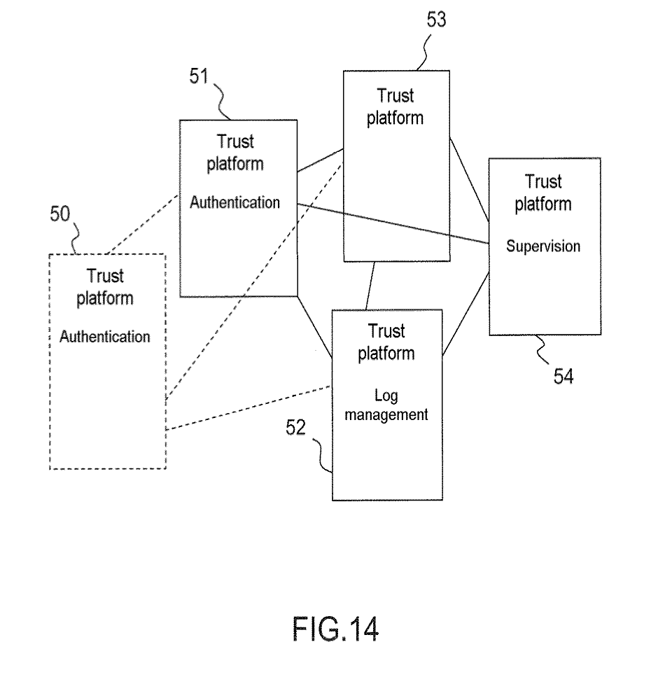

In this FIG. 14, the unified and universal management system comprises an MMI or federating portal 40 allowing the interface with various applications. This MMI interface is connected with a bus, for example, a message-oriented software bus or JMS, 41. From this bus, the user can access various applications, for example:

42—personalization of the equipment, applying the key, etc.
43—management of the equipment (defining security policies, managing populations, signing software, etc.)
44—supervision of the equipment (managing incidents, alarms, logs),
45—managing identifications and authentications
46—other applications.

The various applications communicate with cryptographic equipment 47 using standard communication protocols such as SNMP, SYSLOG, TFTP, NETCONF, NTP, etc.

FIG. 14 schematizes an example of a trust distributed hardware implementation.

In this implementation example, the system comprises for example an authentication trust platform 50 at the service of all the equipment if the first encryptor is insufficient, an authentication trust platform 51 at the service of all the equipment, a platform 52 for managing logs at the service of all the equipment, a trust platform 53 suitable for processing the items of equipment that do not necessarily have a service to offer, a trust platform 54 suitable for supervision at the service of all the items of equipment.

The present invention makes it possible to add as many services/machines as necessary: it is the adaptability of the principle used by the invention. The various services may be distributed over several hardware machines. The system according to the invention is notably compatible with an implementation on:
ad hoc networks,
grids distributing data or services,
firewall management systems better known as “UTM” (Unified Threat Management) available at http://en.wikipedia.org/wiki/Unified_Threat_Management.

The interfaces between the various services should be protected by means of protocols protected against the risks run (example: IPsec, SSL, etc.).

The system according to the invention notably provides the following advantages:
An adaptation of the concept to all types of cryptographic equipment (encryptors, terminals, resources, injectors, onboard components, etc.)
The mutualization of common services (authentication, logging, secrets management, etc.)
The independence of the services: cohesive structuring of components and clarification of the interfaces, services specific to certain items of equipment, possibility of easily partitioning the data and the functions by level, identification of the inter-level interfaces, etc.
The capacity to easily externalize certain services: the concept of MUGUET administration makes the externalization of certain services easier: supervision, production, maintenance, nevertheless without requiring or imposing totally different means.
A specialism-oriented user-friendliness of the “Look and Feel” type;
A considerable upgrade capability;
An ability to interface with existing elements or external systems;
A concept that can be applied to a single workstation as well as to a cross-disciplinary management infrastructure,
A reference model making it possible to make various management architectures cohesive,
An architecture allowing distribution of the management or administration operations in space and in time (the intervention of different operators at different times and places: preparation, operation, supervision, maintenance, etc.).

1. A unified and universal management system for one or more items of cryptographic equipment, the management system having a services-oriented architecture, the management system comprising:
a federating portal that is adapted to a user to allow the user to access individual and independent services, said individual and independent services comprising one or more of the following technology modules:
a secrets management module to provide at least one of key production, directory management, access to secrets produced, allocation management of secrets, and generation of associated keys;
a security policy management module to provide at least one of a protection policy, an access control policy, an IPSec security policy, access to the protection policy, access to the access policy, and generation of secrets;
an operational policy and parameters module to provide at least one of information that the one or more items of cryptographic equipment needs outside the security policy management module, and definition of one or more additional operational parameters of the one or more items of cryptographic equipment;
an administration module; to provide at least one of pre-personalization, personalization, registration, assignment of the pre-personalization data to the one or more items of cryptographic equipment, and enrollment of the one or more items of cryptographic equipment;
a supervision module to provide at least one of alarms management, management of technical facts, reporting of incidents and unsolicited events, viewing a state of a service, viewing a state of equipment monitoring the service, and correlation of events;
an audit module to provide at least one of an audit of the correct application of the Security Policy, including logs and policy applied, consulting logs and database of entities that maintain service, auditing the logs and the policies of the one or more items of cryptographic equipment, and analyzing the logs;
a monitoring module to provide at least one of population management, status and location of the one or more items of cryptographic equipment, and maintenance of an equipment status database; and
an authentication module to provide at least one of management of user profiles, user authentication, and access to services;
the management system further comprising one or more interfaces to allow the interchange of information between the management system and the one or more items of cryptographic equipment outside the management system.

2. The unified management system according to claim 1, wherein said one or more technology modules comprise three layers corresponding to a unified service.

3. The unified management system according to claim 2, wherein the three layers comprise:
a first layer corresponding to a man-machine interface presentation module;
a second layer corresponding to one or more desired processes; and
a third layer corresponding to a database,
wherein the processes of the second layer interact with the man-machine interface presentation module of the first layer and with the database of the third layer.

4. The unified management system according to claim 1, wherein the services-oriented architecture comprises:
the authentication module;
the security policy management module suitable to generate secrets; and
the audit module.

5. The unified management system according to claim 1, comprising:
the authentication module to authenticate and to access the services;
the secrets management module to access the secrets produced, to manage allocation of secrets, and to generate associated keys;
the audit module to audit the local logs;
the security policy management module to define a policy for access to the one or more items of cryptographic equipment;
the administration module to supply pre-personalization data and assigning the pre-personalization data to the one or more items of cryptographic equipment;
the monitoring module to maintain an equipment status database.

6. The unified management system according to claim 1, comprising:
the authentication module to authenticate and to access the services;
the security policy management module to define one or more policies of the one or more items of cryptographic equipment; and
the audit module to audit the local logs.

7. The unified management system according to claim 1, comprising:
the authentication module to authenticate and to access the services;
the audit module to audit the local logs;
the security policy management module to access the policy to be allocated to the one or more items of cryptographic equipment;
the operational policy and parameters module to define one or more additional operational parameters of the one or more items of cryptographic equipment; and
the administrative module to perform at least one of supplying the one or more items of cryptographic equipment with configuration data and updating the operational parameters.

8. The unified management system according to claim 1, comprising:
the authentication module to authenticate and to access the services;
the security policy management module to access the IPSec security policy as part of a policy allocated to the one or more items of cryptographic equipment to be managed;
the secrets management module to access the secrets produced, and to manage allocation of secrets;
the operational policy and parameters module to define one or more additional operational parameters of the one or more items of cryptographic equipment;
the administrative module to perform at least one of enrolling the one or more items of cryptographic equipment in the management system, personalizing the one or more items of cryptographic equipment, and providing the one or more items of cryptographic equipment with the configuration files in order to control the one or more items of cryptographic equipment remotely;
the supervision module to view, in one or more forms, the state of service and the state of equipment monitoring the service;
the audit module to perform at least one of consulting logs and database of entities that maintain the service and checking compliance of the policy applied with the policy defined; and
the monitoring module to maintain an equipment status database.

9. The unified management system according to claim 1, comprising:
the authentication module to authenticate and to access the services;
the security policy management module to apply one or more of the protection policy, the access control policy, and the IPSec security policy by the one or more items of cryptographic equipment; and
the audit module to perform at least one of auditing the logs and the policies of the one or more items of cryptographic equipment, and analyzing the logs.
